(19) United States
(12) Patent Application Publication
(10) Pub. No.: US 2010/0202569 A1
(43) Pub. Date: Aug. 12, 2010

(54) RADIO RECEIVER

(75) Inventors: Shinji Ueda, Yokohama-shi (JP); Takashi Enoki, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/677,792

(22) PCT Filed: Sep. 11, 2007
(86) PCT No.: PCT/JP2007/067676

§ 371 Date: Mar. 11, 2010

(51) Int. Cl. H04L 27/06

(52) U.S. Cl. 375/340

(57) ABSTRACT

A radio receiver which is capable of improving the power consumption efficiency in the analog/digital conversion process. On a radio receiver (100), an undesired wave signal detector section (140) detects the levels of undesired wave signals excluding desirable wave signals, an A/D converter section (120), having N pieces of bit decision sections corresponding to each bit of the maximum number of quantization bits N, performs analog/digital conversion of the quadrature-demodulated signal using only the same number of bit decision sections as the setting number of quantization bits k (k≦N), and a number of bits-control section (155) switches the number of quantization bits k which is set up at the A/D converter section (120) depending on a ratio of the desirable wave signal level to the undesired wave signal level. In such a manner of adaptation to the ratio of the desirable wave signal level to the undesired wave signal level, the number of quantization bits can be increased/decreased. When the number of quantization bits is decreased, the bit decision sections corresponding to the reduced number of bits can be stopped, which assures to improve the power consumption efficiency in the analog/digital conversion process.

### TECHNICAL FIELD

The present invention relates to a radio receiver that switches between a plurality of reception bands having different bandwidths each other to receive radio signals.

### BACKGROUND ART

In a mobile communication system, the bandwidths of transmitted and received radio signals have widened as the required transmission rate increases.

In addition, in order to realize transmission and reception of a signal requiring a low transmission rate in speech communication and so forth and a signal requiring a high transmission rate in data communication such as video communication as well as a signal in a conventional mobile communication system by one radio equipment, transmission and reception in a plurality of radio bandwidths are required. That is, the receiver has to switch reception bandwidths.

Conventionally, there has been a radio receiver adopting AGC (Automatic Gain Control) (see Patent Document 1). The radio receiver disclosed in Patent Document 1 solves a problem that the signal level inputted to an A/D converting section after automatic gain control has been applied is not optimized due to the influence of undesired waves. That is, the radio receiver disclosed in Patent Document 1 has an automatic gain control section, an A/D converting section, a decimation filter and an AGC level detecting section. The AGC level detecting section detects an undesired wave level based on the difference in the level between the input signal and the output signal of the decimation filter. Then, the automatic gain control section performs gain control based on the detected undesired wave level.
Patent Document 1: Japanese Patent Application Laid-Open No. 11-112461.

### DISCLOSURE OF INVENTION

### Problems to be Solved by the Invention

However, when the conventional radio receiver adopting automatic gain control is just applied to a system requiring a radio receiver that can be applied in a plurality of bandwidths, the following problem occurs.

That is, first, the number of quantization bits in the A/D converting section is fixedly set at the time the bandwidth is maximized. Therefore, when a radio receiver receives a signal in a narrow bandwidth, the above-described number of quantization bits is excessive, so that the radio receiver would waste currents in this state.

In addition, the number of quantization bits in the A/D converting section is fixedly set assuming a situation where the undesired wave level is highest. Therefore, if a situation where a high undesired wave level continues, the radio receiver would waste currents.

It is therefore an object of the present invention to provide a radio receiver that allows efficient power consumption in analog-to-digital conversion processing.

### Means for Solving the Problem

The radio receiver according to the present invention has a configuration including: a quadrature demodulating section that quadrature-demodulates a received signal; an undesired signal detecting section that detects a level of an undesired signal other than a desired signal; an analog-to-digital converting section that has N bit determining sections corresponding to bits of a maximum number of quantization bits N, respectively, and analog-to-digital converts demodulated signal using only the same number of the bit determining sections as a number of quantization bits k (k≦N) to be set, the demodulated signal being signal obtained by quadrature-demodulating the received signal; and a control section that switches the number of quantization bits k set in the analog-to-digital converting section in accordance with a level ratio of the level of the detected undesired signal to a level of the desired signal.

### Advantageous Effects of Invention

According to the present invention, a radio receiver that allows efficient power consumption in analog-to-digital conversion processing can be provided.

### BRIEF DESCRIPTION OF DRAWINGS

FIG. 1 is a block diagram showing a configuration of a radio receiver according to embodiment 1 of the present invention;

FIG. 2 is a drawing schematically showing states of input signals or output signals of components in FIG. 1;

FIG. 3 is a drawing explaining a relationship between reception bandwidths used to receive a radio signal and undesired wave levels, and required dynamic ranges for the A/D converting section and the number of quantization bits that can be set in the A/D converting section;

FIG. 4 is a drawing explaining operations of a variable gain amplifying section and the A/D converting section;

FIG. 5 is a block diagram showing a configuration of the A/D converting section;

FIG. 6 is a drawing showing a configuration of a variable bit width analog-to-digital converting circuit;

FIG. 7 is a drawing showing a relationship between a control signal inputted to each bit determining section of the variable bit width analog-to-digital converting circuit in FIG. 6 and a state of each bit determining section in accordance with the control signal;

FIG. 8 is a drawing explaining operations of the variable gain amplifying section and the A/D converting section according to embodiment 2;

FIG. 9 is a drawing showing a configuration of the variable bit width analog-to-digital converting circuit; and

FIG. 10 is a drawing showing a relationship between a control signal inputted to each bit determining section of the variable bit width analog-to-digital converting circuit in FIG. 9 and a state of each bit determining section in accordance with the control signal.

### BEST MODE FOR CARRYING OUT THE INVENTION

Now, embodiments of the present invention will be described in detail with reference to the drawings. Here, in the embodiments, the same components will be assigned the same reference numerals and overlapping descriptions will be omitted.

### Embodiment 1

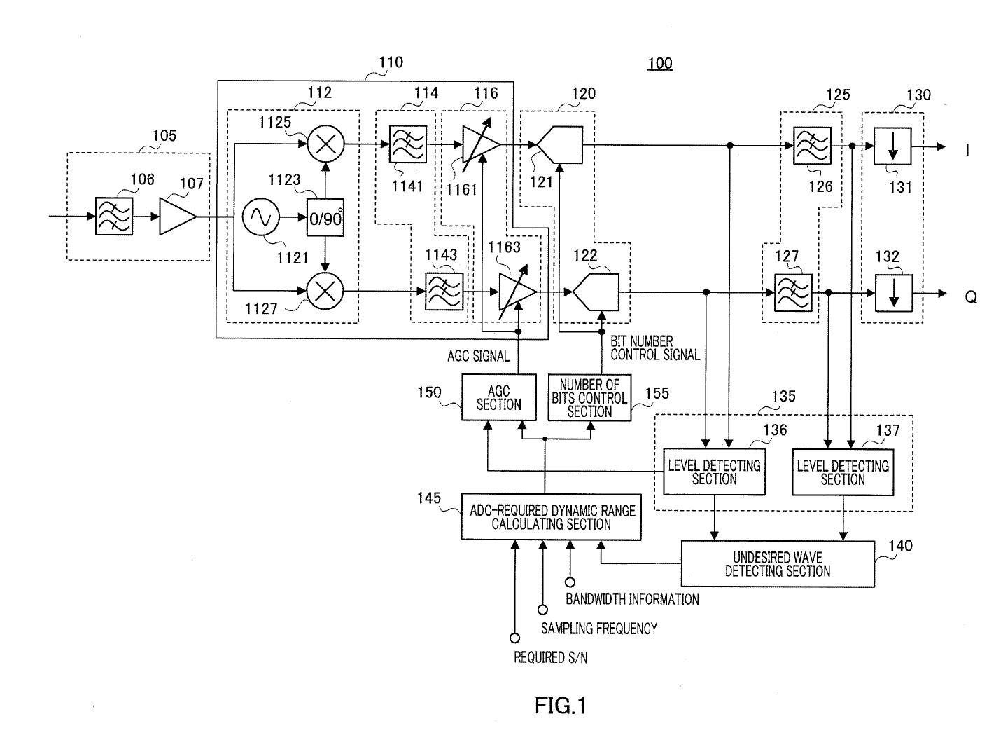

As shown in FIG. 1, radio receiver 100 according to the present embodiment has high frequency section 105, analog receiving section 110, A/D converting section 120, decimation filter section 125, decimating section 130, level detecting section 135, undesired wave detecting section 140, ADC-required dynamic range calculating section 145, AGC (Automatic Gain Control) section 150 and number of bits-control section 155. Radio receiver 100 switches between a plurality of reception bands having different bandwidths each other to receive radio signals.

High frequency section 150 is composed of bandpass filter 106 and low noise amplifier 107 and has a function for attenuating the frequency of the band other than the required band, from the radio signal received by an antenna and amplifying the frequency of the required band. That is, high frequency section 105 suppresses undesired waves and amplifies the desired wave.

Analog receiving section 110 has quadrature demodulating section 112, analog filter 114 and variable gain amplifying section 116.

Quadrature demodulating section 112 has local oscillator 1121, 90-degree shifter 1123 and multipliers 1125 and 1127. Quadrature demodulating section 112 quadrature-demodulates the received signal obtained via high frequency section 105 to produce an I (In-phase) signal, which is an inphase component, and a Q (Quadrature) signal, which is a quadrature component.

Analog filter section 114 has analog LPF 1141 that filters the I signal obtained from multiplier 1125 and analog LPF 1143 that filters the Q signal obtained in multiplier 1127.

Variable gain amplifying section 116 has variable gain amplifier 1161 that amplifies the I signal obtained via analog LPF 1141 in accordance with an AGC signal and variable gain amplifier 1163 that amplifies the Q signal obtained via analog LPF 1143 in accordance with the AGC signal.

A/D converting section 120 has AD converter 121 that converts the analog I signal amplified in variable gain amplifying section 116 to a digital I signal in accordance with a number of bits-control signal, and AD converter 122 that analog-to-digital converts the Q signal amplified in variable gain amplifying section 116 in accordance with the number of bits-control signal.

Decimation filter section 125 has decimation filter 126 that allows only the desired I signal to pass through and removes undesired signals other than the desired I signal and decimation filter 127 that allows only the desired Q signal to pass through and removes undesired signals other than the desired Q signal.

Decimating section 130 has decimating section 131 that decimates the I signal obtained via decimation filter section 125 and reduces the sampling rate and decimating section 132 that decimates the Q signal obtained via decimation filter section 125 and reduces the sampling rate.

Level detecting section 135 has level detecting section 136 and level detecting section 137. Level detecting section 135 detects input signal levels of decimation filter section 125 and output signal levels of decimation filter section 125. Input signal levels of decimation filter section are detected in level detecting section 136 while output signal levels of decimation filter section 125 are detected in level detecting section 137.

Undesired wave detecting section 140 finds the difference between the input signal level (reception level) of decimation filter section 125 detected in level detecting section 136 and the output signal level (desired wave level) of decimation filter section 125 detected in level detecting section 137 to calculate the undesired wave level. Undesired wave detecting section 140 calculates the ratio between the desired wave level and the calculated undesired wave level and outputs the obtained ratio of the undesired wave level to the desired wave level, to ADC-required dynamic range calculating section 145.

ADC-required dynamic range calculating section 145 calculates the dynamic range required in A/D converting section 120 based on the undesired signal level detected in undesired wave detecting section 140, the reception bandwidth, the sampling frequency for analog-to-digital conversion and the required S/N (Signal-to-Noise Ratio). Here, the ratio of the undesired wave level to the desired wave level is used for the undesired signal level.

In addition, ADC-required dynamic range calculating section 145 calculates a gain set in variable gain amplifying section 116 based on the undesired signal level detected in undesired wave detecting section 140, the reception bandwidth, the sampling frequency for the analog-to-digital conversion and the required S/N.

AGC section 150 adjusts the gain calculated by ADC-required dynamic range calculating section 145 based on the reception level detected in level detecting section 136 and the dynamic range calculated by ADC-required dynamic range calculating section 145. This adjusted gain is outputted as an AGC signal.

Number of bits-control section 155 determines the number of quantization bits based on the dynamic range calculated by ADC-required dynamic range calculating section 145. This number of quantization bits is outputted to A/D converting section 120 as a number of bits-control signal.

Next, operations of radio receiver 100 having the above-described configuration will be described.

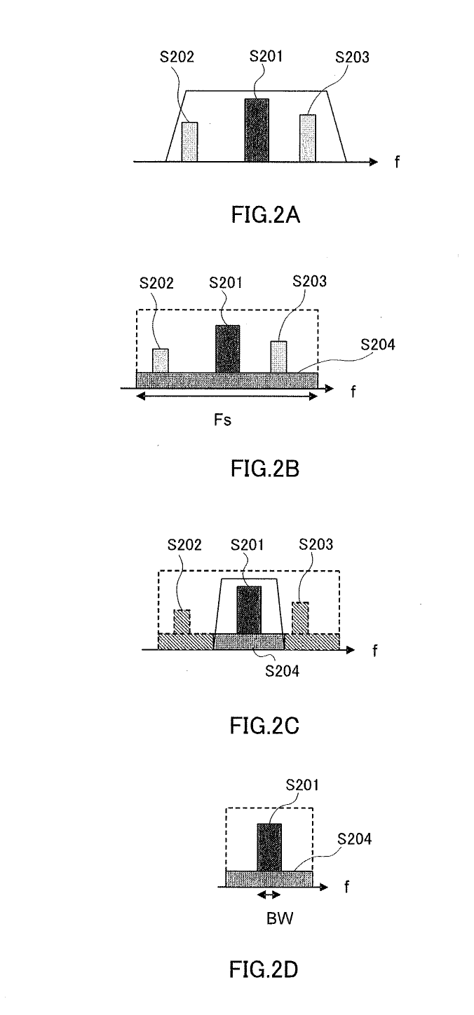

FIG. 2 is a drawing schematically showing states of input signals or output signals of components in FIG. 1. FIG. 2A shows an output signal of variable gain amplifying section 116 (an input signal of A/D converting section 120). FIG. 2B shows an output signal of A/D converting section 120. FIG. 2C shows an output signal of decimation filter section 125. FIG. 2D shows an output signal of decimating section 130.

As shown in FIG. 2A, the output signal of variable gain amplifying section 116 includes desired signal (desired wave) S201 and undesired signals (undesired waves) S202 and S203. This output signal of variable gain amplifying section 116 is inputted to A/D converting section 120 and analog-to-digital converted in A/D converting section 120. As shown in FIG. 2B, the output signal of A/D converting section 120 includes quantization noise S204 superimposed thereon in analog-to-digital conversion. Bandwidth Fs in FIG. 2B corresponds to the sampling frequency.

Decimation filter section 125 allows a component of the output signal from A/D converting section 120, within the band corresponding to the band including the desired signal, to pass through. Therefore, as shown in FIG. 2C, the components corresponding to undesired signals (undesired waves) S202 and S203 are removed from the output signal of decimation filter section 125. Decimating section 130 reduces the sampling rate of the signal within the band corresponding to the band including the desired signal having passed through decimation filter section 125. BW in FIG. 2D corresponds to the signal bandwidth.

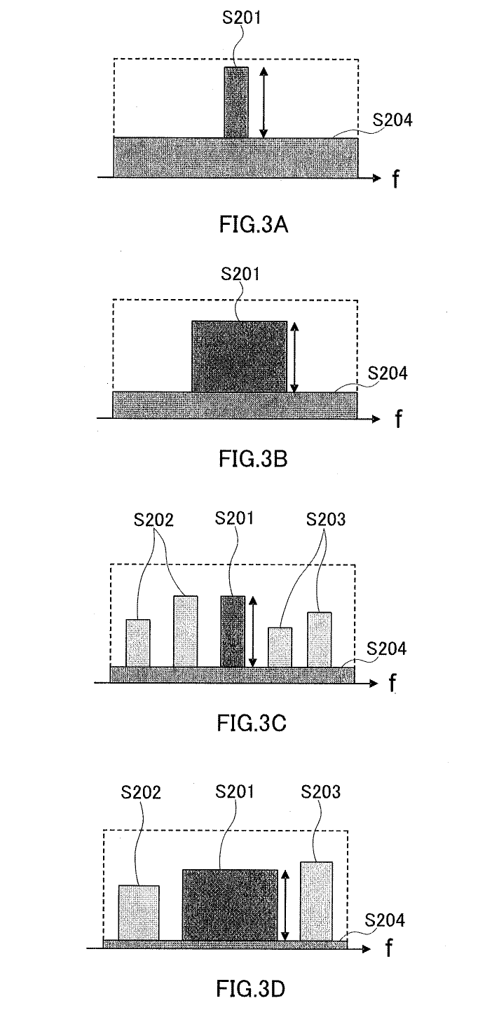

Next, a relationship between reception bandwidths used to receive a radio signal and undesired wave levels, and required dynamic ranges for A/D converting section 120 and the number of quantization bits that can be set in A/D converting section 120 will be described with reference to FIG. 3.

FIG. 3A shows an output signal of A/D converting section 120 when a narrow reception band is used and the undesired wave level is low. In this case, since a narrow reception band is used, the level of the portion of quantization noise S204 overlapping the band of the desired signal is low. Therefore, the quantization noise has little influence on the desired signal, so that the number of quantization bits can be set small.

FIG. 3B shows an output signal of A/D converting section 120 when a wide reception band is used and the undesired wave level is low. In this case, since a wide reception band is used, the level of the portion of quantization noise S204 overlapping the band of desired signal S201 is relatively high. Therefore, the number of quantization bits has to be set larger than the number when a narrow reception band is used and the undesired wave level is low.

FIG. 3C shows an output signal of A/D converting section 120 when a narrow reception band is used and the undesired wave level is high. In this case, since the undesired wave level is high, the required dynamic range of A/D converting section 120 has to be large, but since a small is used, the level of the portion of quantization noise S204 overlapping desired signal S201 is low. Therefore, the quantization noise has little influence on the desired signal, so that the number of quantization bits can be set small.

FIG. 3D shows the output signal of A/D converting section 120 when a wide reception band is used and the undesired wave level is high. In this case, since the undesired wave level is high, the required dynamic range in A/D converting section 120 has to be large, and, in addition, since a wide reception band is used, the level of the portion of quantization noise S204 overlapping desired signal S201 becomes relatively high. Therefore, the number of quantization bits has to be set larger than the number when a narrow reception band is used and the undesired wave level is high.

Here, ADC-required dynamic range calculating section 145 calculates the required dynamic range in the following flow.

First, the noise level n₀ after decimation is calculated by the following equation.

n₀=signal level/(S/N)=d/a

Next, the input level X of A/C converting section 120 is calculated by the following equation.

X=desired wave+undesired wave=d+d/r=(1+1/r)·d

Then, the required dynamic range is calculated by the following equation.

DR=input level X/quantization noise=X/(n₀·(Fs/BW))=(1+1/r)·a·BW/Fs

Here, in the above equations, a means the required S/N, r means the ratio between the received power D of the desired wave and the received power U of the undesired wave. d means the desired wave level and n₀ means the noise in the bandwidth of the signal after decimation. BW means the bandwidth of the signal and Fs means the sampling frequency.

Here, the dynamic range obtained by reflecting the influence of the signal peak and fading fluctuation on the required dynamic range calculated by the above-described equations may be used as the required dynamic range. This influence of the signal peak and fading fluctuation is about 20 dB.

To sum up the above-described descriptions, ADC-required dynamic range calculating section 145 calculates the desired dynamic range in accordance with the ratio of the undesired wave level to the desired wave level. To be more specific, the lower the ratio of the undesired wave level to the desired wave level is, the larger the value of the required dynamic range is.

Further, ADC-required dynamic range calculating section 145 calculates the required dynamic range in accordance with the reception band that is used. To be more specific, the wider the reception band used is, the larger the value of the required dynamic range is. To be more specific, ADC-required dynamic range calculating section 145 calculates the required dynamic range in accordance with the product of the reciprocal of the ratio of the undesired wave level to the desired wave level and the reception bandwidth used.

Since the required dynamic range and the number of quantization bits are proportional to each other, the trend of the required dynamic range is applicable to the number of quantization bits as it is.

Thus, the number of quantization bits reflecting that trend is determined by number of bits-control section 155. This determined number of quantization bits is the minimum number of quantization bits that can provide the desired S/N for a combination of the detected undesired wave level, the sampling rate and the reception bandwidth that is used.

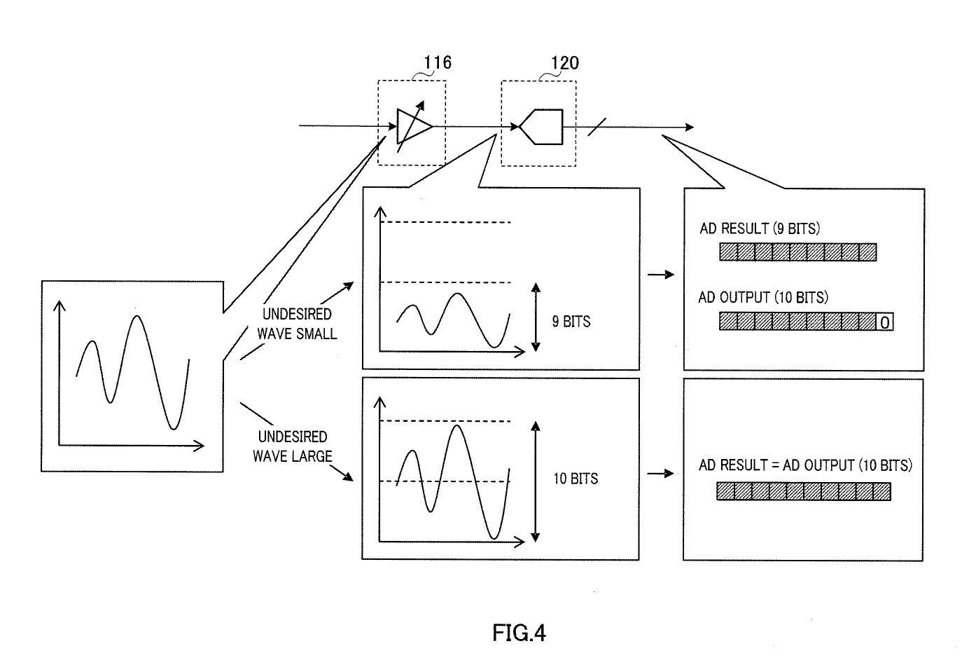

Number of bits-control section 155 switches the number of quantization bits in accordance with the ratio of the undesired wave level to the desired wave level. To be more specific, the smaller the ratio of the undesired wave level to the desired wave level is, the larger the value of the number of quantization bits is (see FIG. 4). Number of bits-control section 155 switches the number of quantization bits in accordance with the reception band that is used. To be more specific, the wider the reception band used is, the lager the value of the number of quantization bits is. To be more specific, number of bits-control section 155 switches the number of quantization bits in accordance with the product of the reciprocal of the ratio of the undesired wave level to the desired wave level and the reception bandwidth used. In addition, when the ratio of the undesired wave level to the desired wave level is large, AGC section 150 sets the gain of variable gain amplifying section 116 to a smaller value than the value when the ratio of the undesired wave level to the desired wave level is small. Moreover, when a narrow reception band is used, AGC section 150 sets the gain of variable gain amplifying section 116 to a smaller value than the value when a wide reception band is used.

To be more specific, AGC section 150 reduces the gain such that the input level to A/D converting section 120 is halved every time the maximum number of quantization bits is reduced one bit. In FIG. 4, the number of quantization bits reduces from the maximum number of quantization bits 10 to the number of quantization bits 9, and therefore the amplitude of the output signal of variable gain amplifying section 116 for the maximum number of quantization bits 10 is twice the amplitude for the number of quantization bits 9. In this way, the input level to A/D converting section 120 can be a level suitable for the number of quantization bits. In the present embodiment, when the number of quantization bits is reduced as described later, bits are reduced in order from the most significant bit. Therefore, the scale of the area which can be quantized appropriately when the number of quantization bits is 10 is twice the scale of the area which can be quantized appropriately when the number of quantization bits is 9. That is, an appropriate input level to A/D converting section 120 when the number of quantization bits is 9 is half the input level when the number of quantization bits is 10.

A/D converting section 120 performs analog-to-digital conversion with the number of quantization bits set by number of bits-control section 155. Here, when the smaller number of quantization bits than the maximum number of quantization bits accepted by A/D converting section 120 is set, a bit string consisting of the number of bits corresponding to that specified number of quantization bits is obtained as a result of the analog-to-digital conversion. However, when the obtained bit string is outputted directly, AGC would operate inappropriately to set the gain large although such a large gain is not necessary. Therefore, by moving bits in the obtained bit string to the high-order bit side and makes the least significant bit 0, A/D converting section 120 outputs a bit string consisting of the number of bits corresponding to the maximum number of quantization bits.

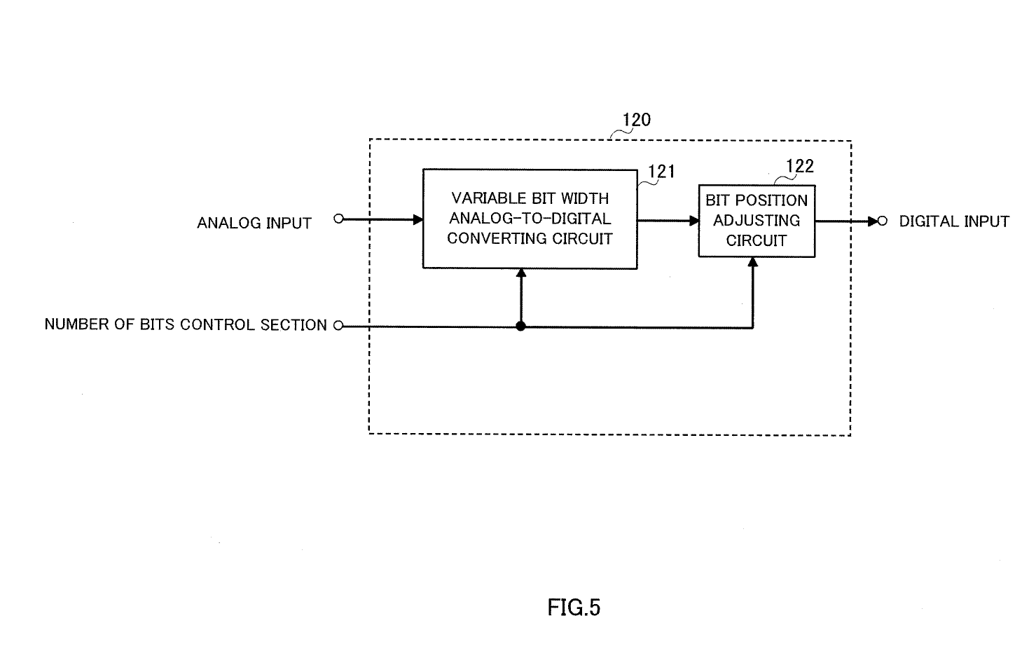

Here, for example, A/D converting section 120 has a configuration as shown in FIG. 5. That is, A/D converting section 120 has variable bit width analog-to-digital converting circuit 121 and bit position adjusting circuit 122.

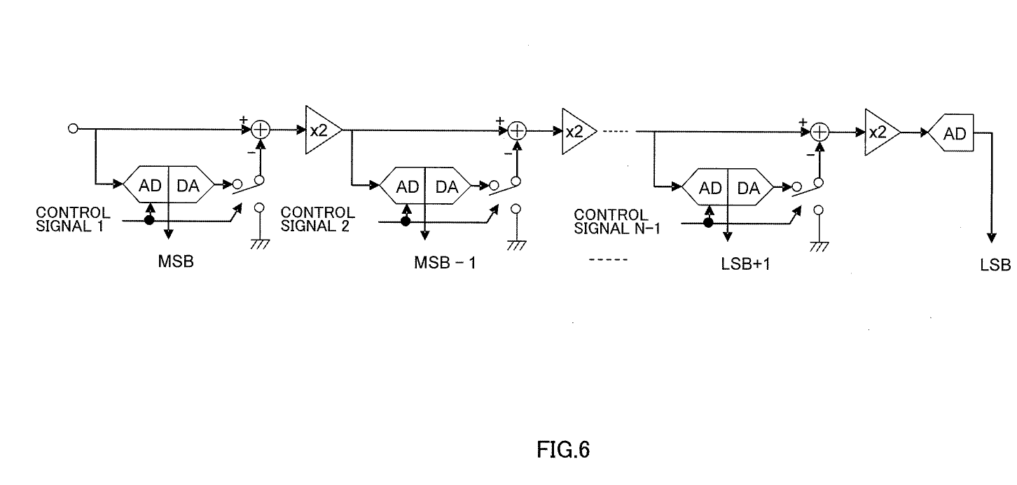

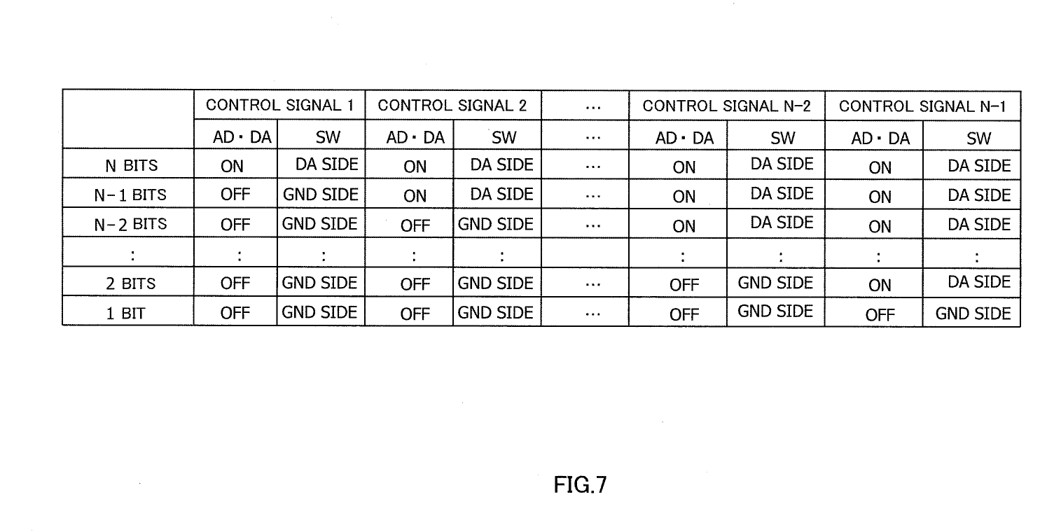

Variable bit width analog-to-digital converting circuit 121 has a multistage bit determination processing function as shown in FIG. 6, for example. Each stage corresponds to one bit of a quantization bit string. Hereinafter, a configuration corresponding to each stage may be referred to as a bit determining section. In variable bit width analog-to-digital converting circuit 121, from the input side, the bit determining section corresponding to the most significant bit (MSB) and the bit determining section corresponding to the least significant bit (LSB) are arranged in order. A control signal is inputted to each bit determining section. Each bit determining section is turned on/off based on the control signal. In addition, each bit determining section controls an input of an analog signal to an adder obtained by D/A-converting the quantization bit obtained by A/D-converting by turning on/off the switch based on the control signal. FIG. 7 shows contents of control signals corresponding to the number of quantization bits (1 to N).

As evidenced by FIG. 4 to FIG. 7, in the present embodiment, when the smaller number of quantization bits than the maximum number of quantization bits is set in A/D converting section 120, bits of a bit string consisting of the maximum number of quantization bits are deleted in order from the most significant bit. Therefore, the bit determining sections in variable bit width analog-to-digital converting circuit 121 shown in FIG. 6 are stopped in order from the bit determining section corresponding to the most significant bit.

Thus, the bit determining sections corresponding to the bits deleted as a result of reducing the number of quantization bits can be stopped, so that wasteful use of electric power in radio receiver 100 can be prevented.

When the number of quantization bits indicated by the number of bits-control signal is smaller than the maximum number of quantization bits, bit position adjusting circuit 122 forms a bit string including the same number of 0 as the difference between the maximum number of quantization bits and the number of quantization bits indicated by the number of bits-control signal (corresponding to the deleted number of bits) behind the obtained bit string, and outputs the obtained bit string to the subsequent stage.

Next, calculating the required dynamic range, determining the number of quantization bits and setting AGC levels will be described in detail. Here, radio receiver 100 has reception bandwidths of 5 MHz and 20 MHz, and the required SNR is 20 dB for both reception bandwidths. Moreover, the sampling rate is 40 MHz for both reception bandwidths.

[In a Case in which the Undesired Wave Level is Low and the Reception Bandwidth Used is 5 MHz]

Assuming that the signal level is 1 and the undesired wave level is 9 after decimation filtering when an output signal level of A/D converting section 120 is 10, DUR, the ratio of the undesired wave level to the desired wave level, is 1/9.

A dynamic range calculated using the above-described equation is as follows.

(1+9)·100/(40/5)=125 (i.e., 21 dB)

By reflecting the influence of the signal peak and fading fluctuation on the resultant, the required dynamic range is 21+20=41 dB.

By increasing the number of quantization bits by one bit every dynamic range of 6 dB, the number of quantization bits is 7 bits.

Assuming that the maximum number of quantization bits is 10 bits, the gain set in variable gain amplifying section 116 is halved every time the maximum number of quantization bits 10 is reduced one bit. That is, in this case, since 3 bits are deleted from the maximum number of bits, the AGC level is set (1/2)³=0.125 times as high as the AGC level for the maximum number of quantization bits.

[In a Case in which the Undesired Wave Level is Low and the Reception Bandwidth Used is 20 MHz]

A dynamic range calculated using the above-described equation is as follows.

(1+9)·100/(40/20)=500 (i.e., 27 dB).

By adding the influence of the signal peak and fading fluctuation to the resultant, the required dynamic range is 27+20=47 dB.

By increasing the number of quantization bits by one bit every dynamic range of 6 dB, the number of quantization bits is 8 bits.

Therefore, the AGC level is set at this time (1/2)²=0.25 times as high as the AGC level for the maximum number of quantization bits.

[In a Case in which the Undesired Wave Level is High and the Reception Bandwidth Used is 5 MHz]

Assuming that the signal level is 1 and the undesired wave level is 39 after decimation filtering when the output signal level of A/D converting section 120 is 40, DUR, the ratio of the undesired wave level to the desired wave level, is 1/39.

A dynamic range calculated using the above-described equation is as follows.

(1+39)·100/(40/5)=500 (i.e., 27 dB)

By reflecting the influence of the signal peak and fading fluctuation on the resultant, the required dynamic range is 27+20=47 dB.

By increasing the number of quantization bits by one bit every dynamic range of 6 dB, the number of quantization bits is 8 bits.

Therefore, the ADC level is set at this time (1/2)²=0.25 times as high as the AGC level for the maximum number of quantization bits.

[In a Case in which the Undesired Wave Level is High and the Reception Bandwidth Used is 20 MHz]

A dynamic range can be calculated using the above-described equation as follows.

2000(1+39)·100/(40/20)=2000 (i.e., 33 dB)

By reflecting the influence of the signal peak and fading fluctuation on the resultant, the required dynamic range is 33+20=53 dB.

By increasing the number of quantization bits by one bit every dynamic range 6 dB, the number of quantization bits is 9 bits.

Therefore, the AGC level is set at this time 1/2=0.5 times as high as the AGC level for the maximum number of quantization bits.

As described above, according to the present embodiment, radio receiver 100 has: quadrature demodulating section 112 that quadrature-demodulates received signals; undesired wave detecting section 140 that detects levels of undesired signals other than the desired signal; A/D converting section 120 that has N bit determining sections corresponding to the maximum number of quantization bits N, respectively and analog-to-digital converts the quadrature-demodulated signal using only the same number of bit determining sections as the number of quantization bits to be set k (k≦N); and number of bits-control section 155 that switches the number of quantization bits k set in A/D converting section 120 in accordance with the ratio of the undesired wave level to the desired signal level (undesired wave level-to-desired wave level ratio).

As a result of this, the number of quantization bits can be increased and reduced in accordance with the ratio of the undesired wave level to the desired wave level. When the number of quantization bits is set smaller than the maximum number of quantization bits, operations of the bit determining sections corresponding to the deleted bits can be stopped, so that electrical power in analog-to-digital conversion processing can be efficiently consumed.

To be more specific, number of bits-control section 155 sets the number of quantization bits smaller (larger) as the ratio of the undesired wave level to the desired wave level increases (reduces). In the present embodiment, particularly, when the number of quantization bits k is set to a smaller value than the maximum number of quantization bits N, bits are deleted in order from the most significant bit.

As a result of this, the optimum number of quantization bits in accordance with the ratio of the undesired wave level to the desired wave level can be set.

That is, for example, when the ratio of the undesired wave level to the desired wave level is small, if a large number of quantization bits is set, analog-to-digital conversion is performed excessively accurately. The reason is as follows. A small ratio of the undesired wave level to the desired wave level means a large percentage of the desired wave, and therefore, when the ratio of the undesired wave level to the desired wave level is small, the required S/N can be satisfied by reducing the number of quantization bits even if quantization noise increases. Nevertheless, a large number of quantization bits is set when the ratio of the undesired wave level to the desired wave level is small, which means that the analog-to-digital conversion is performed with an excessive number of quantization bits.

On the other hand, when the ratio of the undesired wave level to the desired wave level is large, it is necessary to set a large number of quantization bits. The reason is as follows. A large ratio of the undesired wave level to the desired wave level means a small percentage of the desired wave. Therefore, if the quantization noise increases by reducing the number of quantization bits, the desired wave may be lost in the quantization noise.

In addition, number of bits-control section 155 switches the number of quantization bits k in accordance with the ratio of the undesired wave level to the desired wave level and the reception bandwidth.

As a result of this, even if the reception bandwidth is changed, analog-to-digital conversion can be performed with the number of quantization bits suitable for the reception bandwidth applied. That is, when the number of quantization bits smaller than the maximum number of quantization bits is enough for the analog-to-digital conversion depending on the reception bandwidth, the number of quantization bits is reduced and the function parts for performing the analog-to-digital conversion processing corresponding to those deleted bits, so that efficient power consumption in analog-to-digital conversion can be allowed.

Moreover, variable gain amplifying section 116 that amplifies input signals of A/D converting section 120 with the gain corresponding to the difference between the maximum number of quantization bits N and the number of quantization bits k. Here, as described above, bits corresponding to the difference between the maximum number of quantization bits N and the number of quantization bits k are deleted from the bit string consisting of the maximum number of quantization bits N in order from the most significant bit.

As a result of this, for each number of quantization bits k, the scale of the region, which narrows as the number of quantization bits reduces and which can be quantized appropriately, can be matched with the scale of the input level to A/D converting section 120. That is, the input signal level of A/D converting section 120 can be adjusted to a level allowing quantization with the specified number of quantization bits k.

### Embodiment 2

In embodiment 1, the variable gain amplifying section reduces the input level to the A/D converting section by half every time the number of quantization bits set in the A/D converting section reduces one bit from the maximum number of quantization bits. In addition, when the number of quantization bits set in the A/D converting section is smaller than the maximum number of quantization bits, the A/D converting section deletes bits in order from high-order bits. On the other hand, in the present embodiment, the variable gain amplifying section sets a gain allowing the input signal level of A/D converting section to be the acceptable maximum level of the A/D converting section. In addition, the number of quantization bits set in the A/D converting section is smaller than the maximum number of quantization bits, A/D converting section deletes bits in order from low-order bits.

That is, in the present embodiment, AGC section 150 sets, to A/D converting section 120, a gain allowing the input signal level of A/D converting section 120 to be the acceptable maximum input level to AD converting section 120 based on the level detected in level detecting section 136. In other words, the input level to A/D converting section 120 is substantially fixed regardless of the number of quantization bits set in A/D converting section 120. Here, the percentage of the desired wave increases as the number of quantization bits reduces (corresponding to increase of the ratio of the undesired wave level to the desired wave level). Therefore, the fixed input level to A/D converting section 120 regardless of the number of quantization bits means that input signals are amplified with a large gain when the ratio of the undesired wave level to the desired wave level is larger. As described later, in A/D converting section 120, the width between adjacent bit determining thresholds is set wider as the number of quantization bits reduces. Therefore, the input level to A/D converting section 120 is fixed regardless of the number of quantization bits, and therefore, for each number of quantization bits, the input level to A/D converting section 120 can be matched with the scale of the width between bit determining thresholds.

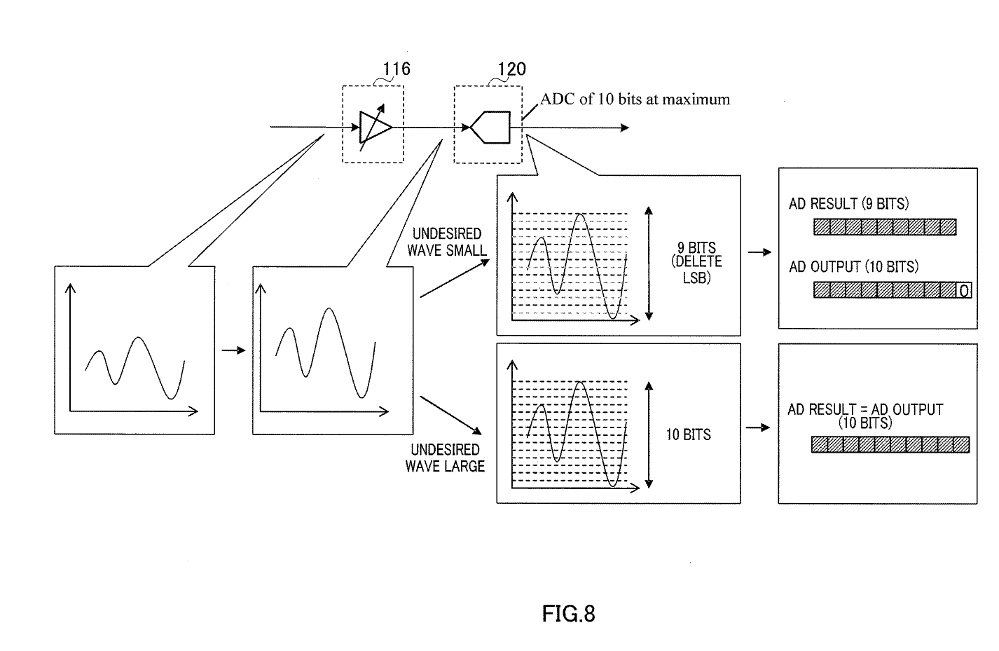

A/D converting section 120 performs analog-to-digital conversion with the number of quantization bits set by number of bits-control section 155. Here, when the number of quantization bits smaller than the maximum number of quantization bits accepted by A/D converting section 120 is set, the result of the analog-to-digital conversion provides a bit string consisting of that specified number of quantization bits. However, when the obtained bit string is outputted directly, AGC section 150 would operate inappropriately to set the gain large although such a large gain is not necessary. For this reason, A/D converting section 120 moves bits in the obtained bit string to the high-order bit side and makes the least significant bit 0 and therefore outputs a bit string consisting of the number of bits corresponding to the maximum number of quantization bits (see FIG. 8).

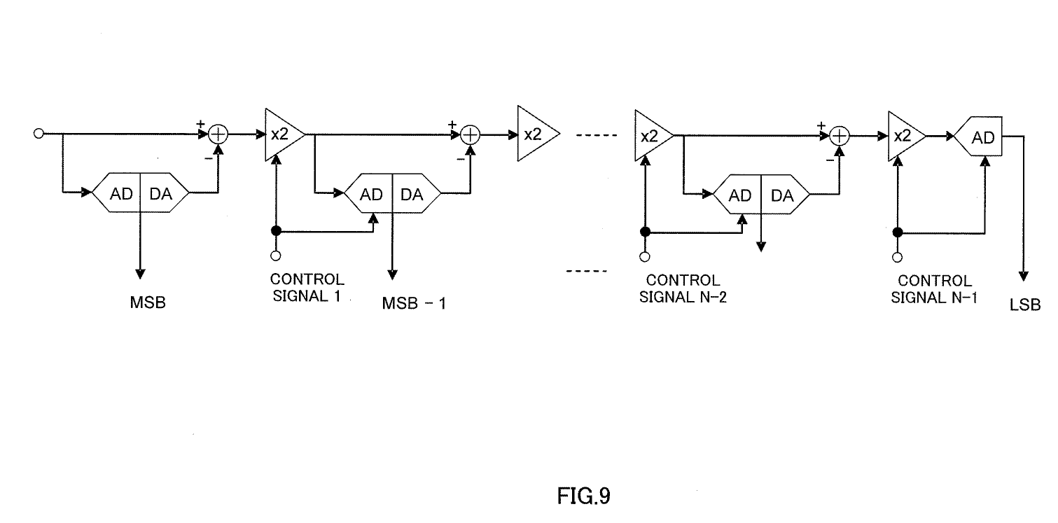

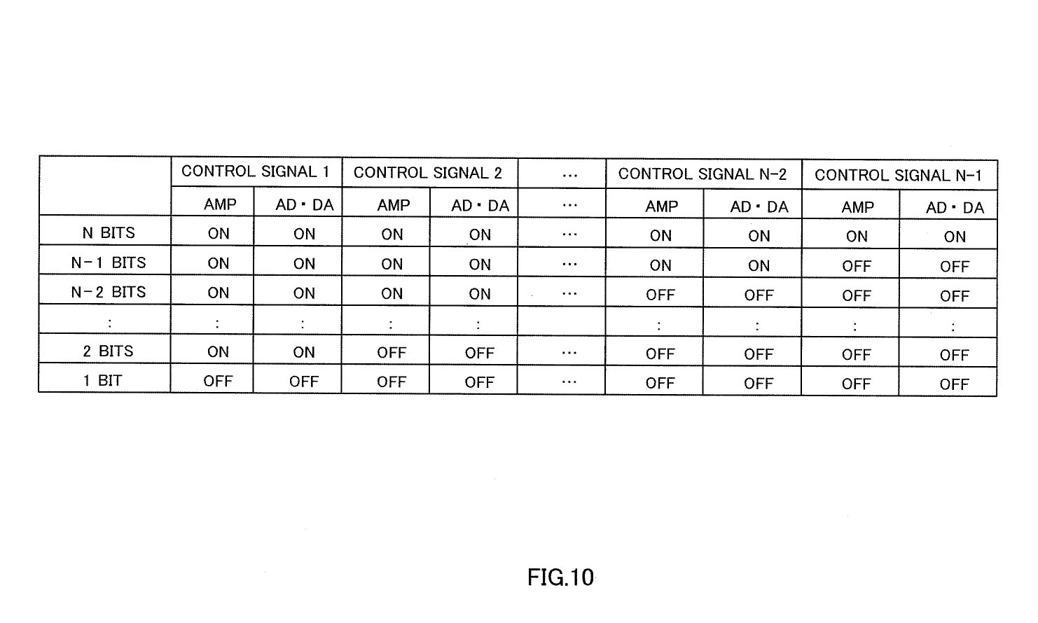

Here, variable bit width analog-to-digital converting circuit 121 in A/D converting section 120 has the multistage bit determining processing function as shown in FIG. 9, for example. Each determining section is turned on/off based on the control signal. In addition, each bit determining section controls an input of an analog signal to an adder obtained by D/A-converting the quantization bit obtained by A/D-converting by turning on/off the switch based on the control signal. Contents of the control signal corresponding to the number of quantization bits (1 to N) are shown in FIG. 10.

In the present embodiment, as evidenced by FIG. 8 and FIG. 10, when the number of quantization bits smaller than the maximum number of quantization bits is set in A/D converting section 120, bits are deleted in order from the least significant bit in a bit string consisting of the maximum number of quantization bits. Therefore, bit determining sections in variable bit width analog-to-digital converting circuit 121 shown in FIG. 9 are stopped in order from the bit determining section corresponding to the least significant bit. Moreover, since bits are deleted in order from the least significant bit, the width between adjacent bit determining thresholds is set to be wider as the number of quantization bits reduces in A/D converting section 120.

Next, calculating the required dynamic range, determining the number of quantization bits and setting AGC levels will be described in detail. Here, radio receiver 100 has reception bandwidths of 5 MHz and 20 MHz, and the required SNR is 20 dB in both reception bandwidths. In addition, the sampling rate is 40 MHz in both reception bandwidths.

[In a Case in which the Undesired Wave Level is Low and the Reception Bandwidth Used is 5 MHz]

Assuming that the signal level is 1 and the undesired wave level is 9 after decimation filtering when an output signal level of A/D converting section 120 is 10, DUR, the ratio of the undesired wave level to the desired wave level is 1/9.

A dynamic range calculated using the above-described equation is as follows.

(1+9)·100/(40/5)=125 (i.e., 21 dB)

By reflecting the influence of the signal peak and fading fluctuation on the resultant, the required dynamic range is 21+20=41 dB.

By increasing the number of quantization bits by one bit every dynamic range of 6 dB, the number of quantization bits is 7 bits.

The AGC level is always set to the value for the maximum quantization level.

[In a Case in which the Undesired Wave Level is Low and the Reception Bandwidth Used is 20 MHz]

A dynamic range calculated using the above-described equation is as follows.

(1+9)·100/(40/20)=500 (i.e., 27 dB)

By reflecting the influence of the signal peak and fading fluctuation on the resultant, the required dynamic range is 27+20=47 dB.

By increasing the number of quantization bits by one bit every dynamic range of 6 dB, the number of quantization bits is 8 bits.

[In a Case in which the Undesired Wave Level is High and the Reception Bandwidth Used is 5 MHz]

Assuming that the signal level is 1 and the undesired wave level is 39 after decimation filtering when an output signal level of A/D converting section 120 is 40, DUR, the ratio of the undesired wave level to the desired wave level, is 1/3.

A dynamic range calculated using the above-described equation is as follows.

(1+39)·100/(40/5)=500 (i.e., 27 dB)

By reflecting the influence of signal peak and the fading fluctuation on the resultant, the required dynamic range is 27+20=47 dB.

By increasing the number of quantization bits by one bit every dynamic range of 6 dB, the number of quantization bits is 8 bits.

[In a Case in which the Undesired Wave Level is High and the Reception Bandwidth Used is 20 MHz]

A dynamic range calculated using the above-described equation is as follows.

(1+39)·100/(40/20)=2000 (i.e., 33 dB)

By reflecting the influence of the signal peak and fading fluctuation on the resultant, the required dynamic range is 33+20=53 dB.

By increasing the number of quantization bits by one bit every dynamic range 6 dB, the number of quantization bits is 9 bits.

As described above, in radio receiver 100 according to the present embodiment, variable gain amplifying section 116 amplifies input signals of A/D converting section 120 such that input levels of the analog-to-digital converting means are substantially fixed, and when the number of quantization bits k is smaller than the maximum number of quantization bits N of A/D converting section 120, A/D converting section 120 stops the same number of bit determining sections as the difference between k and N in order from the bit determining section corresponding to the least significant bit.

As a result of this, for each of the number of quantization bits, the scale of the width between adjacent bit determining thresholds, narrowing as the number of quantization bits reduces can be matched with the scale of the input level to A/D converting section 120.

### Another Embodiment

(1) If the undesired wave is sufficiently suppressed by bandpass filter 106 of high frequency section 105, ADC-required dynamic range calculating section 145 and number of bits-control section 155 may operate as follows.

That is, in a case in which the undesired signal level detected in undesired wave detecting section 140 is lower than a predetermined value, number of bits-control section 155 changes the number of quantization bits in A/D converting section 120 only when the reception bandwidth used is switched.

In addition, when the undesired signal level detected in undesired wave detecting section 140 is lower than a predetermined value, ADC-required dynamic range calculating section 145 calculates a dynamic range based on the reception bandwidth, the sampling frequency for the analog-to-digital conversion and the required S/N except for the undesired signal level.

(2) When the reception bandwidth is fixed and fluctuation of the undesired wave level is large, ADC-required dynamic range calculating section 145 and number of bits-control section 155 may operate as follows.

That is, after the reception bandwidth is switched, number of bits-control section 155 changes the number of quantization bits in A/D converting section 120 only when the undesired signal level detected in undesired wave detecting section 140 fluctuates by an amount equal to or more than a certain value until the reception bandwidth is switched next.

In addition, after the reception bandwidth is switched, ADC-desired dynamic range calculating section 145 calculates an initial value of the dynamic range based on the undesired signal level detected in the undesired wave detecting section 140, the reception width, the sampling frequency for the analog-to-digital conversion and the required S/N, and after calculating the initial value, ADC-desired dynamic range calculating section 145 calculates the dynamic range using only the undesired signal level detected in undesired wave detecting section 140 and the required S/N.

(3) Here, although reception bandwidth information is used in each above-described embodiment, system information may be used instead of reception bandwidth information when the reception bandwidth is uniquely determined by the receiving system. In addition, although SNR allowing the error rate to be equal to or less than a specified value is generally used as the required SNR, amplitude fluctuation caused by fading or amplitude fluctuation of the modulated wave itself (e.g., peak-to-average ratio) may be added to the required SNR.

### INDUSTRIAL APPLICABILITY

The radio receiver according to the present invention is useful to allow efficient power consumption in analog-to-digital conversion processing.

1. A radio receiver comprising:
a quadrature demodulating section that quadrature-demodulates a received signal;
an undesired signal detecting section that detects a level of an undesired signal other than a desired signal;
an analog-to-digital converting section that has N bit determining sections corresponding to bits of a maximum number of quantization bits N, respectively, and analog-to-digital converts demodulated signal using only the same number of the bit determining sections as a number of quantization bits k (k≦N) to be set, the demodulated signal being signal obtained by quadrature-demodulating the received signal; and
a control section that switches the number of quantization bits k set in the analog-to-digital converting section in accordance with a level ratio of the level of the detected undesired signal to a level of the desired signal.

2. The radio receiver according to claim 1, wherein:
the radio receiver switches between a plurality of reception bands having different bandwidths each other to receive a radio signal; and
the control section switches the number of quantization bits k in accordance with the level ratio and the reception bandwidth.

3. The radio receiver according to claim 2, wherein:
the radio receiver switches between the plurality of reception bands having the different bandwidths each other to receive the radio signal; and
the control section switches the number of quantization bits k in accordance with a product of the level ratio and the reception bandwidth.

4. The radio receiver according to claim 2, wherein the control section includes:
a calculating section that calculates a dynamic range required in the analog-to-digital converting section based on the level ratio and the reception bandwidth; and
a number of quantization bits-determining section that determines the number of quantization bits k based on the dynamic range calculated.

5. The radio receiver according to claim 4, wherein the calculating section calculates the dynamic range without using the level ratio when the level ratio is smaller than a predetermined value.

6. The radio receiver according to claim 4, wherein:
when calculating an initial value of the dynamic range after the reception bandwidth is switched, the calculating section calculates the dynamic range based on the level ratio and the reception bandwidth; and
after the initial value is calculated, the calculating section calculates the dynamic range without using the reception bandwidth until the reception bandwidth is switched next.

7. The radio receiver according to claim 1, further comprising a variable gain amplifying section that amplifies an input signal of the analog-to-digital converting section with a gain in accordance with a difference between the maximum number of quantization bits N and the number of quantization bits k.

8. The radio receiver according to claim 7, wherein:
when the number of quantization bits k is smaller than the maximum number of quantization bits N, the analog-to-digital converting section stops the same number of the bit determining sections as the difference between N and k in order from a bit determining section corresponding to a most significant bit; and
the variable gain amplifying section amplifies the input signal of the analog-to-digital converting section with the gain reducing as the difference between N and k increases.

9. The radio receiver according to claim 1, further comprising a variable gain amplifying section that amplifies an input signal of the analog-to-digital converting section such that an input level to the analog-to-digital converting section becomes substantially fixed, wherein:
when the number of quantization bits k is smaller than the maximum number of quantization bits N in the analog-to-digital converting section, the analog-to-digital converting section stops the same number of the bit determining sections as the difference between N and k in order from a bit determining section corresponding to a least significant bit.

10. The radio receiver according to claim 1, wherein:
the radio receiver switches between a plurality of reception bands having different bandwidths each other to receive the radio signal; and
in a case in which the level ratio is smaller than a predetermined value, the analog-to-digital converting section changes the number of quantization bits k only when a reception bandwidth is switched.

11. The radio receiver according to claim 1, wherein after the reception bandwidth is switched, the analog-to-digital converting section changes the number of quantization bits k only when the level of the detected undesired signal fluctuates by an amount equal to or more than a certain value until the reception bandwidth is switched next.
